(19) United States
(12) Patent Application Publication
(10) Pub. No.: US 2009/0318201 A1
(43) Pub. Date: Dec. 24, 2009

(54) Earpiece Cable Control

(76) Inventors: Titta Wiberg, Hämeenlinna (FI); Terhi Wallin, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/087,358

(22) PCT Filed: Jan. 2, 2006
(86) PCT No.: PCT/FI2006/000003

§ 371 Date: Apr. 6, 2009

(51) Int. Cl. H04M 1/00; H01B 7/00

(52) U.S. Cl. 455/575.2; 174/50

(57) ABSTRACT

In an apparatus for controlling an earpiece cable, the apparatus has a housing of the earpiece cable. The housing has a first curve, such as a roller, for guiding the earpiece cable and a second curve for guiding the earpiece cable. Furthermore the housing has a handle for moving the curves so that when the earpiece cable is pulled out of the housing the curves are arranged to approach each other and when the earpiece cable is pulled back into the housing the curves are arranged to distance themselves from each other.

### CROSS REFERENCE TO RELATED APPLICATIONS

This application is the U.S. National Stage of International Application Number PCT/FI2006/000003 filed on Jan. 2, 2006 which was published in English on Jul. 12, 2007 under International Publication Number WO 2007/077285.

### TECHNICAL FIELD

The invention concerns an apparatus for controlling an earpiece cable.

### BACKGROUND OF THE INVENTION

In mobile headsets, there are typically at least one or two cables. If the headset is Bluetooth based headset, there is generally one cable coming from electronics to ear. In a normal, phone attachable, headset, there is also a cable from the phone to headset electronics. In any event, these cables turn out to be inconvenient. The cable entangles and grabs into the user. Thereby, the cable can be rather inconvenient. Furthermore, the cable is quite difficult to store, to roll, or to hideout somewhere.

A known solution has been a nick in the headset. Another know solution has been some kind of neckband, wherein the cable has been hidden inside the band. However, there has not been any good mechanism to control the cable properly.

Yet another known solution in patent publication WO 03/103255 describes a carrying device, e.g. neck ribbon for mobile phone. The headset cable is attached as a part of the neck ribbon. However, the solution is limited because the phone and headset must be hanging on the neck of the user.

Furthermore, the solution is not so compact and the cables might still hang uncomfortably.

### SUMMARY OF THE INVENTION

It is therefore the object of the invention to provide an apparatus for more comfortable control of the earpiece cable.

In accordance with an aspect of the invention there is being provided an apparatus for storing an earpiece cable, the apparatus comprising

a housing of the earpiece cable, the housing comprising

a first set of curves for guiding said earpiece cable, a second set of curves for guiding said earpiece cable, wherein the sets are arranged to move so that, when the earpiece cable is pulled out of the housing, the sets are arranged to approach each other and, when the earpiece cable is pulled back into the housing, the sets are arranged to distance themselves from each other.

In various embodiments, the cable is arranged to make small curves inside the housing. When the cable is pulled out, the cable moves along the curves and distance between the curves changes so that hidden cable comes out from the housing. When it is desired to pull the cable back inside the housing, there is a puller, which adjusts the distance so that the cable runs back inside the housing.

The cable is easy to pull out and in. The cable control apparatus is not a big and clumsy component, but maintain the textile-like feel and look. The apparatus is further more suitable for flexible and soft, textile based applications. Thus, the cable can be partly hidden. The apparatus and the housing are thin and possibly soft in some embodiments. The apparatus does not necessarily need expensive components. Furthermore, the apparatus is rather reliable. Yet furthermore the apparatus is convenient to place onto the user, and accordingly it does not hinder the user so much as known solutions.

Yet further embodiments of the invention have been specified in the dependent claims.

### BRIEF DESCRIPTION OF THE DRAWINGS

The invention will now be described, by way of examples only, with reference to the accompanying drawings, in which:

FIG. 1a is a perspective view of an apparatus for controlling an earpiece cable, wherein the cable has been pulled back into the housing in accordance with the invention;

FIG. 1b is a perspective view of the apparatus, wherein the cable has been pulled out of the apparatus in accordance with the invention;

FIG. 2 is a plan view of the apparatus in accordance with the embodiment of FIGS. 1a and 1b;

FIG. 3a is a plan view of the embodiment of FIGS. 1a, 1b and 2 with portions removed to show internal structure, wherein the cable has been pulled back into the housing;

FIG. 3b is a plan view of the embodiment of FIGS. 1a, 1b and 2 with portions removed to show internal structure, wherein the cable has been pulled out of the apparatus; and

FIGS. 4a and 4b are plan views showing a further embodiment of the apparatus with portions removed to show internal structure.

### DETAILED DESCRIPTION

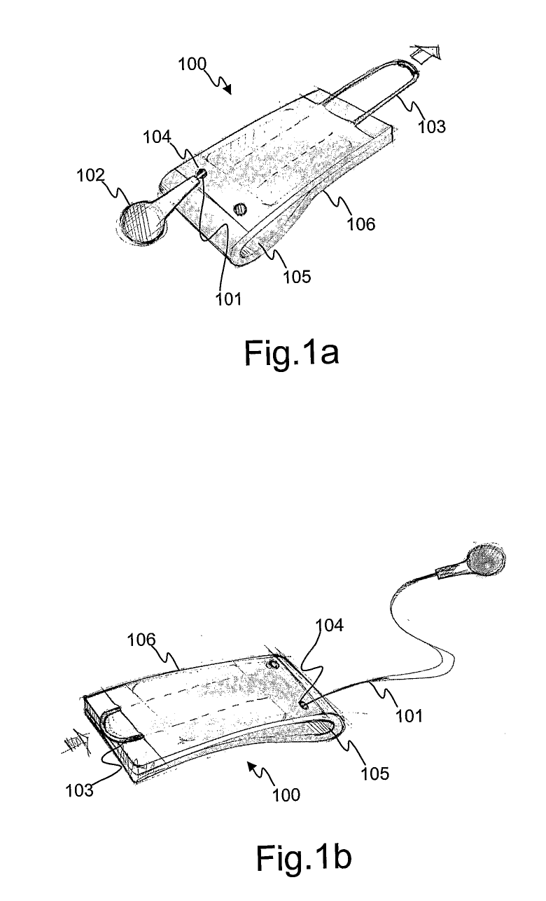

FIG. 1a has been briefly referred above and depicts an apparatus 100 for controlling an earpiece cable 101. An earpiece 102 of the mobile headset (not shown completely) is attached to the cable 101. The cable 101 is pulled into the housing 106 of the apparatus 100 in the embodiments of FIG. 1. The apparatus 100 has a handle 103 for pulling the cable 101 into the apparatus. Furthermore, the apparatus 100 has a hole 104 in the housing 106, through which part of the cable 101 can enter or leave the housing 106. Thus the cable 101 can be pulled into the apparatus 100 via the hole 104. The apparatus 100 is suitable for flexible and soft, textile-based applications, where there is needs to hide the cable 101. The apparatus 100 can furthermore be thin and soft. The apparatus 100 comprises also a cleft 105. The apparatus 100 can be comfortable attached, for example to clothes by the cleft 105. Due to relative small physical size and slim design of the apparatus 100, it is comfortably hanging on the clothes of the user.

Various further embodiments of the invention use the shape and design of the apparatus 100 for attaching the apparatus to the user's clothing. Alternatively, hook and loop materal (e.g., Velcro) or a magnet can be used for attaching the apparatus to the user.

Referring now to FIG. 1b, there is being depicted the apparatus 100, wherein the cable 101 has been pulled out of the housing 106. The handle 103 is moved into the housing 106 as shown in the FIG. 1b. Further part of the cable 101 has come out the housing 106, thereby enabling the user to use the earpiece 102.

In various further embodiments, the freedom of the placement of the apparatus 100 is rather convenient. Generally, it will not hinder the user due to the free placement as long as the length of the cable 101 is enough.

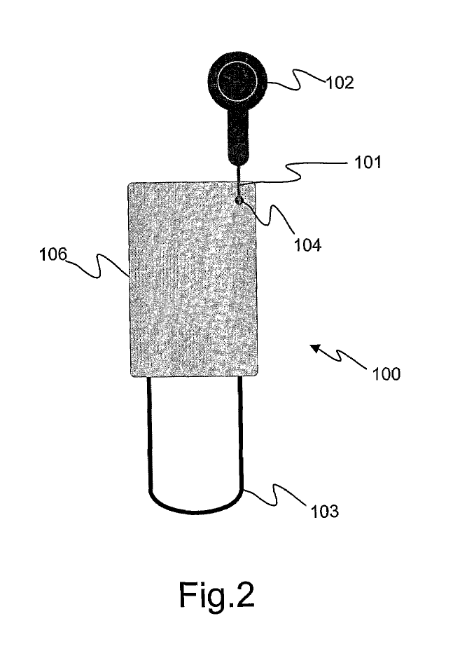

FIG. 2 is a plan view of the apparatus 100 in accordance with the embodiment of FIGS. 1a and 1b of the invention.

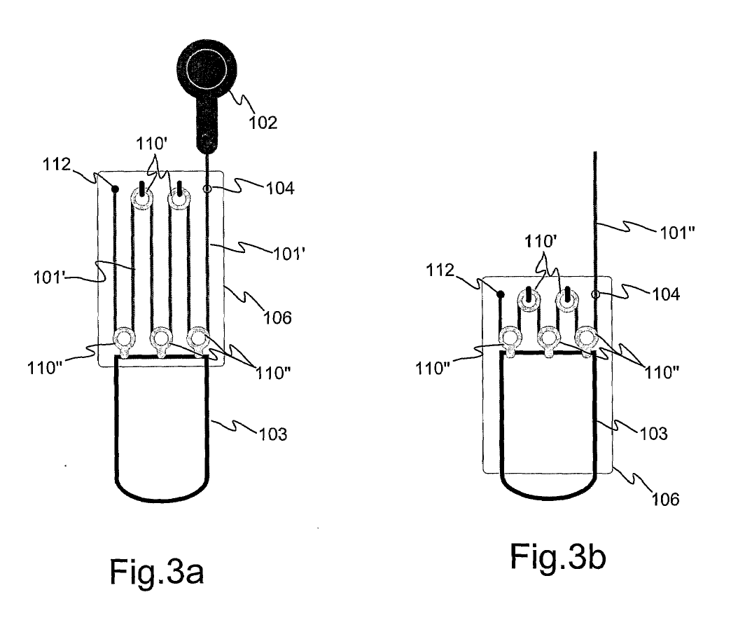

Referring to FIG. 3a, the cable 101 has been pulled back into the housing 106 in accordance with various further embodiments of the invention. The housing 106 has cable 101′ inside. The cable 101′ inside the housing 106 is entangled with rollers 110′ and 110″. Each roller 110′, 110″ comprises a curve, which guides the cable 101′ inside the housing 106. The rollers 110, 110″ can be rotatable. Thus the rollers 110′, 110″ can be rotatably attached to the housing 106 by an axis (not shown). Alternatively rollers 110′, 110″ can be fixedly attached to the housing 106. Thus the cable 101′ may slide along the surface of the rollers 110′, 110″. The rollers 110′ are placed within the housing 106 so that at least one roller 110′ is situated close to the end near the hole 104 and at least one roller 110″ is situated close to the end near the handle 103. An example of the placement of the rollers is shown in FIGS. 3a and 3b. It should be noted that the amount of the rollers and curves, respectively, may vary. Five rollers are shown on FIGS. 3a and 3b only as an example.

Referring again to FIGS. 3a and 3b, the rollers 110″ are connected to the handle 103 by a junction. Thereby, the movement of the handle 103 moves the rollers 110″ respectively. Furthermore, the distance between the rollers 110′ and 110″ varies by the movement. As shown from the example of FIG. 3a, cable 101′ is stored within the housing 106 by the placement of the rollers 110′ and 110″, i.e. by a distance between the rollers 110′ and 110″. The cable 101′ is attached to the housing from an end by a terminal 112.

FIG. 3b depicts the cable 101″ having been pulled out of the housing 106. The distance between the rollers 110′ and 110″ has reduced. A part of the cable 101″ has been pulled out of the housing 106. Thereby the part of the cable 101″ outside the housing 106 has prolonged. The earpiece 102 is now better able to be placed into the user's ear. The user can adjust the distance by the movement of the handle 103. A part of the handle 103 also enters the housing 106.

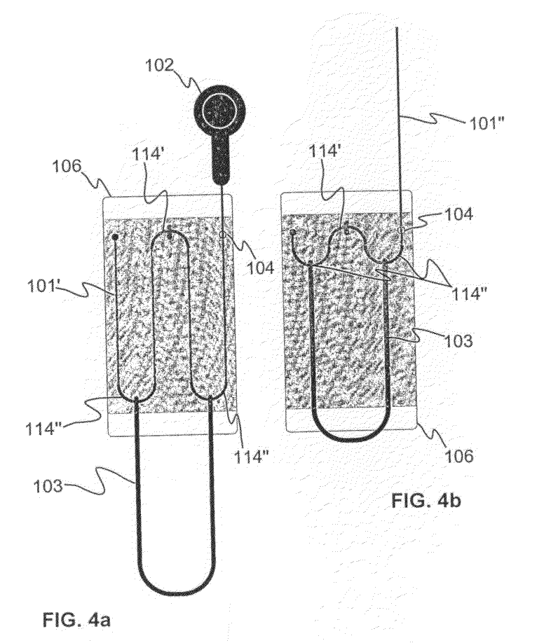

Turning to FIGS. 4a and 4b, therein illustrated is a further embodiment of the apparatus 100. The cable 101′ inside the housing 106 is guided by guides 114′, 114″. Guides 114′, 114″ slidably receive the cable 101′ so that the cable 101′ can slide along the surface thereof. Each guide 114′, 114″ is of a curve shape. The guides 114′, 114″ are placed within the housing 106 so that at least one guide 114′ is situated close to the end near the hole 104 and at least one guide 114″ is situated close to the end near the handle 103. It should be noted that the amount of the guides and curves, respectively, may vary. Three guides are shown in FIG. 4 only as an example. The guides 114″ are connected to the handle 103 by a junction. Thereby, the movement of the handle 103 moves the guides 114″ respectively. Furthermore, the distance between the guides 114′ and 114″ varies by the movement. As shown from the example of FIG. 4a, cable 101′ is stored within the housing 106 by the placement of the guides 114′ and 114″, i.e. by the distance between the guides 114′ and 114″. The cable 101′ is attached to the housing from an end by a terminal 112′.

FIG. 4b also shows the cable 101″ having been pulled out of the housing 106. The distance between the guides 114′ and 114″ has reduced. A part of the cable 101″ has been pulled out of the housing 106. Thereby the part of the cable 101″ outside the housing 106 has prolonged. The user can adjust the distance by the movement of the handle 103. A part of the handle 103 also enters the housing 106.

In various embodiments, the curvesformed by rollers 110′, 110″ or guides 114′, 114″ guide the cable 101 have a slithery surface so that the friction is such that the cable can slide along the surface. Furthermore, the angle of the curves is such that the cable 101 does not get stuck etc. When rotatable rollers 110′, 110″ are used, the angle and the friction are not so meaninful factors. In various further embodiments, the curve can also be flexible so that it bends when the cable 101 is pulled or pushed.

The housing 106 can be made of textile or fabric in the various embodiments. Therefore, the housing 106 fits very well with the clothing. The housing can also be firm material such as plastic etc.

### Ramifications and Scope

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the present invention without departing from the spirit or scope of the invention.

What is claimed is:

1. An apparatus for storing an earpiece cable, the apparatus comprising
a housing for the earpiece cable, the housing comprising
a first set of curves for guiding the earpiece cable, a second set of curves for guiding said earpiece cable, wherein the sets are arranged to move so that when the earpiece cable is pulled out of the housing the sets are arranged to approach each other and when the earpiece cable is pulled back into the housing the sets are arranged to distance themselves from each other.

2. An apparatus according to claim 1, wherein the earpiece cable is arranged to circulate between the curves in turn with respect to the sets so that after passing the curves of the first set the earpiece cable is arranged to pass the curves of the second set until each curve is circulated in turn with respect to the sets.

3. An apparatus according to claim 1, wherein the first set of curves and the second set of curves being arranged substantially close to opposite ends of the housing when a distance between the sets is substantially maximum.

4. An apparatus according to claim 1, wherein each curve of the first set comprises a first roller and each curve of the second set comprises a second roller.

5. An apparatus according to claim 4, wherein at least some of the first and second rollers are rotatable and rotatably coupled with the housing.

6. An apparatus according to claim 4, wherein at least some of the first and second rollers are fixedly attached to the housing so that the cable can slide along a surface thereof.

7. An apparatus according to claim 1, wherein the curves comprise slidable guides so that the cable can slide along a surface thereof.

8. An apparatus according to claim 1, wherein the apparatus further comprises a handle.

9. An apparatus according to claim 8, wherein the handle is connected to the second set of curves so that the second set of curves can be moved by moving the handle.

10. An apparatus according to claim 9, wherein a part of the handle is arranged to be outside the housing and another part of the handle, which is connected to the second set of curves, is arranged to be inside the housing.

11. An apparatus according to claim 10, wherein the first set of curves is anchored to the housing.

12. An apparatus according to claim 1, wherein the apparatus further comprises an attachment means for attaching the apparatus to user's clothing.

13. An apparatus according to claim 12, wherein the attachment means comprises a cleft arranged to the housing so that a piece of clothing can enter said cleft.

14. An apparatus according to claim 12, wherein the attachment means chosen fron the group consisting of hook and loop material and a magnet.

15. An apparatus according to claim 1, wherein the curves are arranged to bend by the movement of the cable so that when the cable is pulled out of the housing the curves store less cable and when the cable is pulled back to the housing the curves store more cable.

16. An apparatus according to claim 1, wherein the cable is anchored to the housing by a terminal.

17. An apparatus according to claim 1, wherein the housing is made from a textile.

18. A mobile phone headset, comprising the apparatus according to claim 1.

19. An apparatus for storing an earpiece cable, the apparatus comprising
a housing of the earpiece cable, the housing comprising
a first set of curves for guiding the earpiece cable, a second set of curves for guiding the earpiece cable, and means for moving the sets so that, when the earpiece cable is pulled out of the housing, the sets are arranged to approach each other and when the earpiece cable is pulled back into the housing the sets are arranged to distance themselves fromn each other.
